(19) United States
(12) Patent Application Publication
(10) Pub. No.: US 2021/0156744 A1
(43) Pub. Date: May 27, 2021

(54) BUILT-IN TEMPERATURE SENSING DEVICE OF SINGLE CHIP AND PROTECTION METHOD THEREOF

(71) Applicant: NUVOTON TECHNOLOGY CORPORATION, Hsinchu City (TW)

(72) Inventor: Chieh-Sheng TU, Hsinchu City (TW)

(21) Appl. No.: 17/039,424

(22) Filed: Sep. 30, 2020

(30) Foreign Application Priority Data
Nov. 21, 2019 (TW) 108142246
Dec. 26, 2019 (TW) 108147914

(51) Int. Cl. G01K 3/00; G08B 21/18; G05B 19/406

(52) U.S. Cl. CPC G01K 3/005; G05B 2219/49216; G05B 19/406; G08B 21/182

(57) ABSTRACT

A built-in temperature sensing device of a single chip includes a built-in temperature sensor and a temperature comparator. The built-in temperature sensor senses a single chip temperature of the single chip. The temperature comparator receives the single chip temperature and a threshold temperature, and compares the single chip temperature with the threshold temperature to generate an output signal to take a necessary protection method.

### FIELD

The disclosure relates to a temperature sensing device, especially relates to a built-in temperature sensing device of single chip and protection method thereof.

### BACKGROUND

With the invention and powerful function of portable or wearable electronic devices, people already have a close connection and communion with portable or wearable electronic devices in their daily lives. Therefore, for the system developers of portable or wearable electronic devices, ensuring their reliability and security is a major issue.

With the frequent use of electronic devices, such as the operation and charging of mobile phones, it becomes more important to detect and protect their over-temperature.

If necessary protective measures are not taken for electronic devices due to the occurrence of over-temperature, it would not only affects the service life of electronic devices, but also affects the safety of life and property of users.

Therefore, how to design a built-in temperature sensing device of a single chip and protection method thereof to solve the aforementioned technical problems is an important studied by the inventor of this case.

### SUMMARY

The purpose of the disclosure is to propose a built-in temperature sensing device of a single chip to solve the problems of prior arts.

To achieve the disclosed purpose, the built-in temperature sensing device of a single chip of the disclosure comprises a built-in temperature sensor, a temperature comparator and a digital to analog converter (D/A converter). The built-in temperature sensor detects a single chip temperature of the single chip. The temperature comparator receives the single chip temperature and a threshold temperature and compares the single chip temperature to the threshold temperature to generate an output signal. The D/A converter couples with the temperature comparator to convert a digital threshold temperature to the threshold temperature. When the single chip temperature is higher than the threshold temperature, the output signal is a first level signal.

In one embodiment, the built-in temperature sensing device of single chip further comprises a time delay controller. The time delay controller receives the output signal and generates a time delay signal.

In another embodiment, the built-in temperature sensing device of single chip further comprises an interrupting controller and a central processing unit (CPU). The interrupting controller receives the output signal and generates an interrupting control signal. The CPU receives the interrupting control signal and generates the digital threshold temperature.

In yet another embodiment, the built-in temperature sensing device of a single chip further comprises an alarm controller and a disable controller. The alarm controller receives the output signal and generates an alarm control signal. The disable controller receives the output signal and generates a disable control signal.

In yet another embodiment, the alarm controller couples with an external alarm device, and activates the external alarm device by the alarm control signal. Wherein the disable controller couples with an external electronic device, and disables the external electronic device by the disable control signal.

In yet another embodiment, according to the extent or duration time of the single chip temperature being higher than the threshold temperature, whether disabling the external electronic device is needed or not is determined.

By the built-in temperature sensing device of a single chip, the detection and protection of over-temperature could be achieved safely, reliably and programmatically.

Another purpose of the invention is to present a protection method of the built-in temperature sensing device of a single chip to solve the existing problems.

To achieve the aforementioned purpose, the protection method of the built-in temperature sensing device of a single chip comprises (a) detecting a single chip temperature of the single chip, (b) comparing the single chip temperature with a threshold temperature to generate an output signal to a disable controller, and (c) generating a disable control signal to disable an external electronic device coupling with the disable controller when the single temperature is higher than the threshold temperature.

In one embodiment, the step (b) further comprises (b1) comparing the single chip temperature with the threshold temperature to generate the output signal to an alarm controller. The step (c) further comprises (c1) generating an alarm control signal by the alarm controller to activate an external alarm device coupling with the alarm controller when the single chip temperature is higher than the threshold temperature.

In another embodiment, the step (c) further comprises: generating the disable control signal by the disable controller to disable the external electronic device after a time delay. Wherein, the step (c1) further comprises: generating the alarm control signal by the alarm controller to activate the external alarm device after a time delay.

In yet another embodiment, the step (c) further comprises: determining whether the external electronic device needs to be disabled or not according to an extent or a duration time of the single chip temperature being higher than the threshold temperature.

By the protection method of a built-in temperature sensing device of a single chip, the detection and protection of over-temperature could be achieved safely, reliably and programmatically.

To facilitate the review of the technique characteristics, contents, advantages, and achievable effects of the present disclosure, the embodiments together with the drawings are described in detail as follows. However, the drawings are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

### BRIEF DESCRIPTION OF THE DRAWINGS

By referring to the attached drawings and embodiments, the above and other characteristics and advantages would be more apparent for the person skilled in the art.

FIG. 1 depicts an image of the first embodiment of the built-in temperature sensing device of the single chip of this invention.

FIG. 2 depicts an image of the second embodiment of the built-in temperature sensing device of the single chip of this invention.

FIG. 3 depicts an image of the third embodiment of the built-in temperature sensing device of the single chip of this invention.

FIG. 4 depicts an image of the fourth embodiment of the built-in temperature sensing device of the single chip of this invention.

FIG. 5 depicts depicts an image of the fifth embodiment of the built-in temperature sensing device of the single chip of this invention.

FIG. 6 depicts an image of the sixth embodiment of the built-in temperature sensing device of the single chip of this invention.

FIG. 7 depicts an image of the seventh embodiment of the built-in temperature sensing device of the single chip of this invention.

FIG. 8 depicts an image of the eighth embodiment of the built-in temperature sensing device of single chip of this invention.

FIG. 9 depicts a flowchart of the protection method of the built-in temperature sensing device of the single chip of this invention.

### DETAILED DESCRIPTION

A more comprehensive illustration of some embodiments are provided below with reference to the attached drawings.

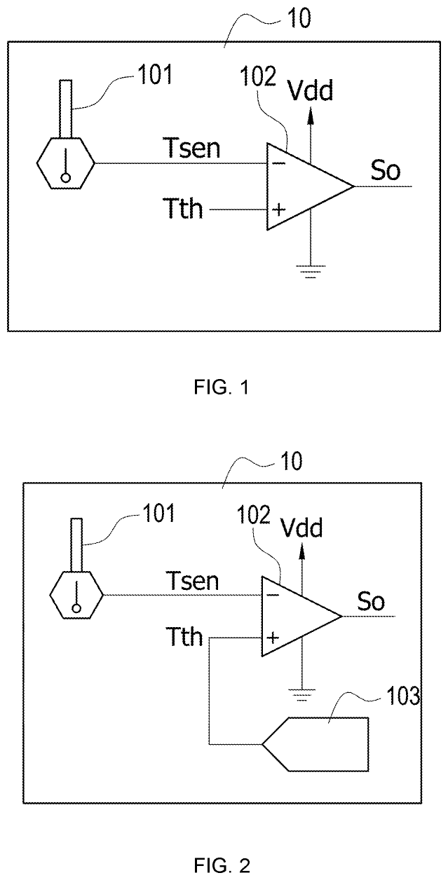

Please refer to FIG. 1, illustrating the image of the first embodiment of the built-in temperature sensing device of single chip of this invention. As shown in FIG. 1, the built-in temperature sensing device of the single chip (hereinafter referred to as the built-in temperature sensing device) is built in a single chip 10. The built-in temperature sensing device comprises a built-in temperature sensor 101 and a temperature comparator 102. The built-in temperature sensor 101 detects a single chip temperature Tsen of the single chip 10. Wherein, the single chip temperature Tsen refers to the sum of the ambient temperature and the heat from the single chip. Specifically, the built-in temperature sensor 101 is the built-in temperature sensor in the single chip 10, which uses the characteristics of the semiconductor interface to detect the temperature of the positive correlation between the current and the temperature. Therefore, in this invention, no additional external temperature sensor is required to detect the single chip temperature Tsen. By doing so, the built-in temperature sensing device can be reduced in size and cost, and more directly reflect the true temperature of the single chip.

The temperature comparator 102 receives the single chip temperature Tsen and a threshold temperature Tth. Wherein, the single chip temperature Tsen and the threshold temperature Tth are both digital values. In one embodiment, the temperature comparator 102 could be implemented by an operational amplifier. Through comparing digital temperature values received by the non-inverting input end with the inverting input end, a high level signal or a low level signal is generated at the output of the temperature comparator 102. The temperature comparator 102 compares the single temperature Tsen and the threshold temperature Tth to generate a output signal So. Wherein, the output signal So is a first level signal when the single chip temperature Tsen is higher than the threshold temperature Tth. On the contrary, the output signal So is a second level signal when the single chip temperature Tsen is lower than the threshold temperature Tth. Wherein, the first level signal is opposite to the second level signal. However, the temperature comparing of the invention should not be limited by the aforementioned operational amplifier. All circuits or components having the function of signal comparison shall be included in the scope of the present invention.

As shown in FIG. 1, the inverting input end receives the single chip temperature Tsen, whereas the non-inverting input end receives the threshold temperature Tth. The temperature comparator 102 generates the low level output signal So when the single chip temperature Tsen is higher than the threshold temperature Tth. On the contrary, the temperature comparator 102 generates the high level output signal So when the single chip temperature Tsen is lower than the threshold temperature Tth. In other words, when the output signal So is low level, the single chip temperature Tsen is higher than the threshold temperature Tth. At the time, the protection or warning mechanism for the response is needed to be activated to protect the system or to provide warning instructions to operators (more on hereafter). However, the invention should not be limited by the aforementioned judgement of level. That is, the non-inverting input end of the temperature comparator 102 could also receive the single chip temperature Tsen, and the inverting input end receives the threshold temperature Tth. In this way, the temperature comparator 102 generates the high level output signal So when the single chip temperature Tsen is higher than the threshold temperature Tth. On the contrary, the temperature comparator 102 generates the low level output signal So when the single chip temperature Tsen is lower than the threshold temperature Tth.

Through the response mechanism activated by the detection and comparison of the single chip temperature Tsen, the application of the single chip is not limited in product stage only. It could have the function in the test stage, so as to improve the yield, reliability and safety after shipment, as well as improve the competitiveness of the product.

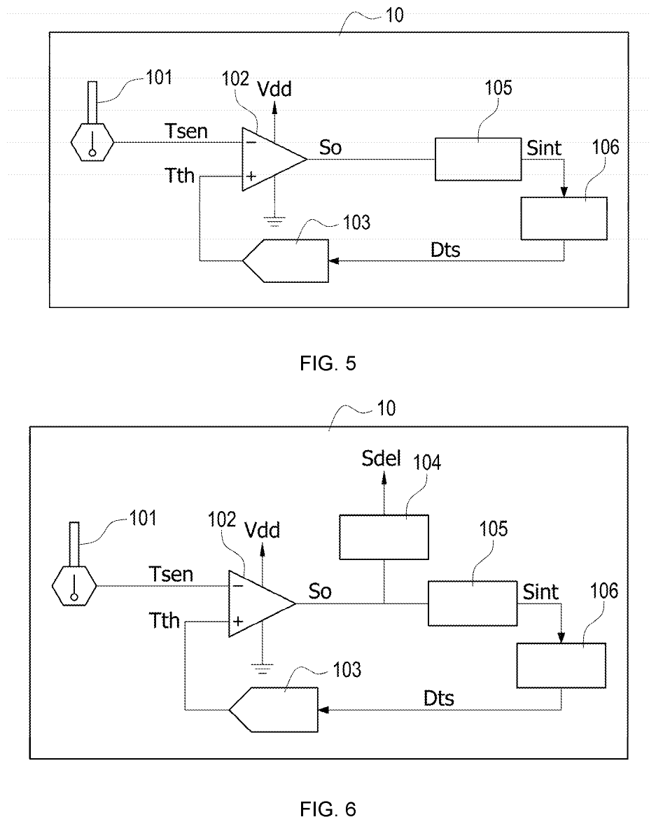

Please refer to FIG. 2, illustrating the image of the second embodiment of the built-in temperature sensing device of single chip of this invention. The main difference between FIG. 2 and FIG. 1 is that the built-in temperature device in FIG. 2 further comprises a digital to analog converter (D/A converter) 103. The D/A converter 103 couples with the temperature comparator 102 to convert a digital threshold temperature Dts to the digital-type threshold temperature Tth. Wherein, the digital threshold temperature Dts is generated by a central processing unit (CPU) 106 (follow the detailed description in FIG. 5).

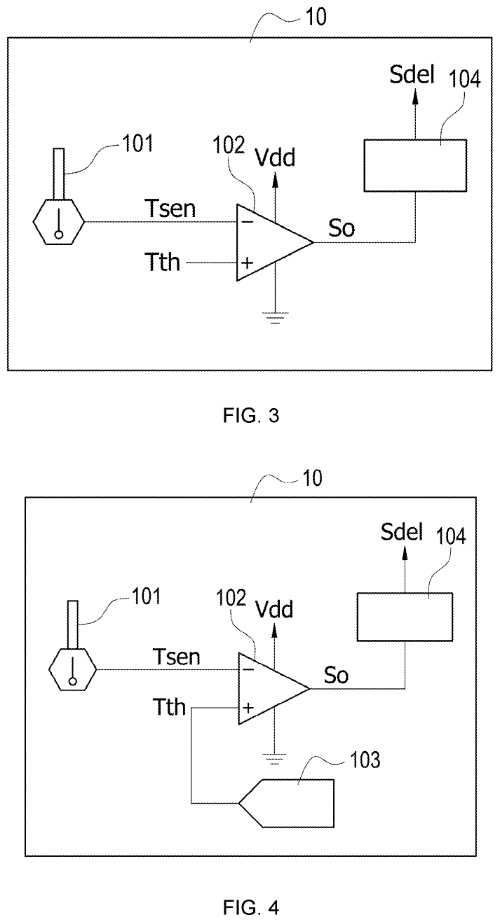

Please refer to FIG. 3, illustrating the image of the third embodiment of the built-in temperature sensing device of the single chip of this invention. The main difference between FIG. 3 and FIG. 1 is that the built-in temperature device in FIG. 3 further comprises a time delay controller 104. The time delay controller 104 couples with the output end of the temperature comparator 102, receives the output signal So, and generates a time delay signal Sdel. Please refer to FIG. 4, illustrating the image of the fourth embodiment of the built-in temperature sensing device of the single chip of this invention. The main difference between FIG. 4 and FIG. 2 is that the built-in temperature device in FIG. 4 further comprises a time delay controller 104. Similarly, the time delay controller 104 couples with the output end of the temperature comparator 102, receives the output signal So, and generates a time delay signal Sdel. The role and operation of the time delay signal Sdel will be described later.

Please refer to FIG. 5, illustrating the image of the fifth embodiment of the built-in temperature sensing device of the single chip of this invention. The main difference between FIG. 5 and FIG. 2 is that the built-in temperature device in FIG. 5 further comprises an interrupting controller 105 and a central processing unit (CPU) 106. The interrupting controller 105 couples with the output end of the temperature comparator 102, receives the output signal So, and generates a interrupting control signal Sint. The CPU 106 couples with the interrupting controller 105, receives the interrupting control signal Sint, and generates the digital threshold temperature Dts. And, the D/A converter 103 converts the digital threshold temperature Dts to the digital-type threshold temperature Tth.

Please refer to FIG. 6, illustrating the image of the sixth embodiment of the built-in temperature sensing device of the single chip of this invention. The main difference between FIG. 6 and FIG. 5 is that the built-in temperature device in FIG. 6 further comprises the time delay controller 104. Similarly, the time delay controller 104 couples with the output end of the temperature comparator 102, receives the output signal So, and generates a time delay signal Sdel.

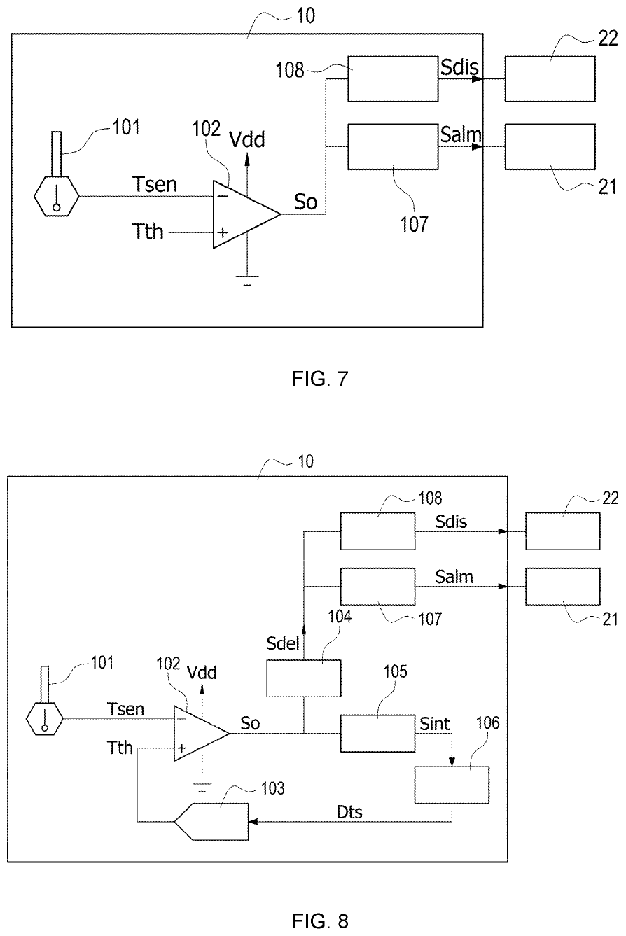

Please refer to FIG. 7, illustrating the image of the seventh embodiment of the built-in temperature sensing device of the single chip of this invention. The main difference between FIG. 7 and FIG. 1 is that the built-in temperature device in FIG. 7 further comprises an alarm controller 107 and a disable controller 108. The alarm controller 107 couples with the output end of the temperature comparator 102, receives the output signal So, and generates an alarm control signal Salm. The disable controller 108 couples with the output end of the temperature comparator 102, receives the output signal So, and generates a disable control signal Sdis. Specifically, the alarm controller 107 couples with an external alarm device 21 implemented at the outside of the single chip 10, and activates the external alarm device 21 through the alarm control signal Salm. The disable controller 108 couples with an external electronic device 22 implemented at the outside of the single chip 10, and disables the external electronic device 22 through the disable control signal Sdis. In this invention, the external alarm device 21 could be a device that instantly notifies and warns by means of sound, light, text, vibration, moving interface, etc. For example, the external alarm device could be a buzzer, light emitting diode indicator light, seven-stage display, vibrating motor, alarm panel, liquid crystal display (LCD), report moving substation, report moving communication interface, picture control software and equipment, etc. However, the scope of this invention should not be limited by the aforementioned device or apparatus. In this invention, the external electronic device 22 could be portable electronic devices, wearable electronic devices or rotating motors such as mobile phones, tablets, laptops, heating devices, electrical devices (e.g. motors), etc. However, the scope of this invention should not be limited by the aforementioned device or apparatus.

Please refer to FIG. 8, illustrating the image of the eighth embodiment of the built-in temperature sensing device of single chip of this invention. FIG. 8 is the most complete embodiment of the invention, which comprises the circuits, devices mentioned in FIG. 1-7. FIG. 8 can provide the most complete operation and function. Hereafter, for the sake of convenience and clarity, the invention is illustrated numerically in accordance with FIG. 1-8. The invention achieves single chip temperature sensing through utilizing the semiconductors interface characteristics of the built-in temperature sensing device of single chip. Therefore, there is no need to use an additional external temperature sensor to detect the temperature of the single chip. Furthermore, as mentioned above, the built-in temperature sensing device of single chip and protection method is not limited to product of single chip application, and can have such function in the test phase.

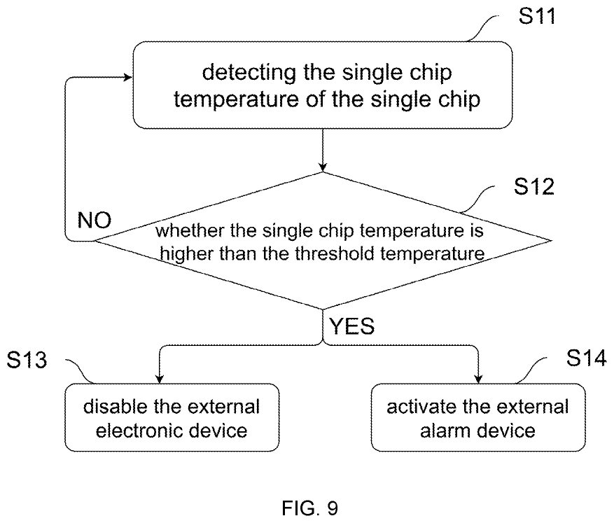

Please refer to FIG. 9, illustrating the flowchart of the protection method of the built-in temperature sensing device of the single chip of this invention. Since the protection method in FIG. 9 has been described in detail in the previous article, the main process steps for this protection mechanism are briefly outlined. Firstly, step S11 is detecting the single chip temperature of the single chip. By detecting the single chip temperature by the built-in temperature sensor of the single chip, there is no need to use an additional external temperature sensor to detect the temperature of the single chip. Then, step S12 is determining whether the single chip temperature is higher than the threshold temperature. By comparing the digital-type single chip temperature and threshold temperature by the temperature comparator, whether the single chip temperature is higher than the threshold temperature could be determined. When the determination of step S12 is “no”, step S11 is implemented to continuously detect the single chip temperature and compare the single chip temperature with the threshold temperature. On the contrary, when the determination of step S12 is “yes”, the single chip temperature is higher than the threshold temperature, and the protection method is implemented.

The protection method comprises step S13: disabling the external electronic device and step S14: activating the external alarm device. In step S13, when the single chip temperature is higher than the threshold temperature, the external electronic device coupling with the disable controller is disabled by the disable controller through the disable control signal in order to protect the external electronic device and the user's safety. Before step S13, importing the time delay is also permitted, so that after the time delay, the disable controller can only disable the external electronic device, so as to avoid the influence of transient temperature abnormalities on the operation of the external electronic devices and user's operation.

In step S14, when the single chip temperature is higher than the threshold temperature, the external alarm device coupling with the alarm controller is activated by the alarm controller through the alarm control signal, in order to achieve immediate alarming effect. Before step S14, importing the time delay is also permitted, so that after the time delay, the alarm controller can only activate the external alarm device, so as to avoid the influence of transient temperature abnormalities on the operation of the external electronic devices and user's operation.

The following will describe the different requirements and situations for the application of the built-in temperature sensing device of single chip.

### Situation 1: Over-Temperature Confirmation and Protection of the Product in User's Operation

For convenience, take the mobile phone as the example of the external electronic device 22, and take the buzzer as the example of the external alarm device 22. Please refer to FIGS. 1, 2 and 7, FIG. 7 illustrate the simplified relative relationship between the single chip 10 and the external electronic device 22. In fact, the single chip 10 is arranged in the external electronic device 22, and the external electronic device 22 means the main components that perform the operation of the external electronic device 22, such as the components that operate on and off. For example, the user uses the mobile phone (i.e the external electronic device 22) for charging or making calls, and it is assumed that the threshold temperature converted by the D/A converter 103 form the digital threshold temperature Dts is 50° C. In user's operation, when the temperature comparator 102 determines the single chip temperature Tsen detected by the built-in temperature sensor is lower than 50° C. (i.e Tsen<Tth), the output signal So generate by the temperature comparator is the high level signal. In this case, since the mobile phone is operated under normal situation, the output signal So won't control the alarm controller 107 to generate the alarm control signal Salm to activate the operation of the external alarm device. At the same time, the output signal So won't control the disable controller 108 to generate the disable control signal Sdis to disable the external electronic device (such as shutting down or stopping charging).

On the contrary, in user's operation, when the temperature comparator 102 determines the single chip temperature Tsen detected by the built-in temperature sensor is higher than 50° C. (i.e Tsen>Tth), the output signal So generate by the temperature comparator is the low level signal. In this case, since the mobile phone is operated under abnormal situation, the output signal So will controls the alarm controller 107 to generate the alarm control signal Salm to activate the operation of the external alarm device, such as the buzzer making sounds (or the vibrating motor continues to vibrate). And the user can be notified of the over-temperature of the mobile phone. Furthermore, the output signal So controls the disable controller 108 to generate the disable control signal Sdis to disable the external electronic device, such as directly shutting the mobile phone down to avoid explosion.

In the aforementioned operation, whether the disable controller 108 generates the disable control signal Sdis to disable the external electronic device 22 is not absolutely necessary. In the design, for example but not limited to, based on the extent or duration of the single chip temperature Tsen being higher than the threshold temperature Tth (i.e the severity of abnormality), whether the external electronic device 22 should be disabled is determined. For example, when the single chip temperature Tsen is 5° C. higher than the threshold temperature Tth, or, when the duration of the single chip temperature Tsen being higher than the threshold temperature Tth for 2 seconds, it can only activate the buzzer to make sounds (or the the vibrating motor continues to vibrate) without directly shutting down the mobile phone. In this way, the user can decide whether to stop the operation at that time. On the contrary, when the single chip temperature Tsen is 20° C. higher than the threshold temperature Tth, or, when the duration of the single chip temperature Tsen being higher than the threshold temperature Tth for 10 seconds, not only the alarm notification of the external alarm device 21 should be activated, but the external electronic device 22 should be disabled (such as shutting down or stopping charging) to ensure the safety of the external alarm device 22 and the user.

In addition, please refer to FIGS. 3 and 4, under the same operation situation, the operation of the time delay controller 104 is further provided. For example, when the temperature comparator 102 determines the single chip temperature Tsen detected by the built-in temperature sensor is higher than the threshold temperature Tth, the external alarm device 21 won't be immediately activated by the alarm controller 107 through the output signal So, and/or disabled the external electronic device 22 by controlling the disable controller 108. Since, the situation of single chip temperature Tsen being higher than the threshold temperature Tth may be due to the influence of transient temperature of the internal circuits, rather than the actual over-temperature anomaly. In other words, after the situation of the transient over-temperature, the single chip temperature Tsen decreases to normal range immediately. Therefore, it may be inconvenient for users if directly activating the external alarm device 21 and even disabling the external electronic device 22. Therefore, the time delay controller 104 can determine whether the transient over-temperature happens. For example, it is assumed that a time delay is set by the time delay controller 104 for 20 ms, i.e, only when the duration of the single chip temperature Tsen is more than 20 ms, the actual over-temperature anomaly is determined. On the contrary, it is determined as the transient over-temperature situation. Therefore, the influence of the operation of the external electronic device 22 due to the transient over-temperature can be avoided.

### Situation 2: Over-Temperature Adjustment and Design During Product Testing

Please refer to FIGS. 5 and 6, unlike situation 1, the built-in temperature sensing device of the single chip further comprises the interrupting controller 105 and the CPU 106. Similarly, taking the mobile phone as the external electronic device 22 as an example, it lies in the over-temperature adjustment and design during the test phase. The CPU 106 can be used to set the threshold temperature Tth in multiple stages (in multiple ranges) for the test of the mobile phone. For example, the system developer first designs a lower threshold temperature Tth which is assumed to be 40° C. Basically, it is reasonable and safe for the single chip temperature Tsen being higher than the threshold temperature Tth when the mobile phone is in charge or in the use of calling. The output signal So is low level signal, and controls the interrupting controller 106 to generate the interrupting control signal Sint, as well as controls the CPU 106 to adjust the digital threshold temperature Dts. Similarly, when over-temperature happens during testing, the external alarm device (such as buzzers) is also activated to notice the alarm immediately. Furthermore, the CPU 106 sets the higher threshold temperature Tth (by increasing the digital threshold temperature Dts), for example, 45° C. In this way, the threshold temperature Tth can be adjusted (turned up) repeatedly in multiple stages until the final adjusted threshold temperature Tth and the single chip are actually over-temperatured (different operation would cause different over-temperature). Thus, the single chip temperature Tsen can match more accurately, and the single chip temperature Tsen wouldn't be over-low to cause frequent protection of over-temperature (alarming the external alarm device 21 and/or disabling the external electronic device 22). Or. The single chip temperature Tsen wouldn't be over-high to incorrectly activate the protection of over-temperature, i.e, the determination of temperature would be more accurate.

Furthermore, the interrupting controller 105 can further control the CPU 106 to determine whether the system design is correct. For example, the system developer can first design the lower threshold temperature Tth, which is the temperature value that will not trigger the over-temperature protection during normal operation. Therefore, during testing, the situation that the single chip temperature Tsen is higher than the threshold temperature Tth frequently means that the system design is wrong. And, unreasonable over-temperature of the single chip temperature Tsen occurs. In this way, the system developer can further check and adjust the system to find the system design errors. In the application of the above test, continuous monitoring can be achieved by recording the change of the single chip temperature Tsen during testing. It is helpful for system developers to know the parameters, electrical characteristics during the test.

Furthermore, the confirmation, adjustment, and operation of design of over-temperature are all available through the wireless way, such as bluetooth, ZigBee, 4G, or, the handled or wearable device of higher mobility standards feature communication protocols with user (or supervisor) to achieve the wireless transmission of data. It will enable the user (or supervisor) to have complete control over the operation of the system.

Through the most complete embodiment of FIG. 8, whether the situation 1 (over-temperature confirmation and protection of the product in use stage), the situation 2 (over-temperature adjustment and design during product testing) or even the operation situation excluded of both situation 1 and 2 can be realized and integrated, so as to achieve the monitoring, recording and comparing of the single chip 10. Furthermore, the over-temperature protection of the external electronic device 22 is achieved, so as to protect the external electronic device 22 and the user's safety.

In summary, this invention has the following characteristics and advantages

1. No additional external temperature detector is needed to detect the single chip temperature Tsen, thereby reducing the size and the cost of the device. Furthermore, the true temperature of the single chip can be reflected more directly.

2. The method activated by the detection and the comparing of the single chip temperature Tsen is not limited within the application of product operation, furthermore, it can also have the function during test stage. By this way, the product yield, reliability, safety and competitiveness would be improved.

3. The CPU 106 design the digital threshold temperature Dts in advance to ensure that in case of failure or busy, the CPU 106 can still maintain the judgment and protection of the over-temperature of the single chip 10.

4. Through the time delay controller 104 setting the time delay, the operation and user's operation of the external electronic device 22 can be prevented from being affected by transient over-temperature anomalies.

5. By adjusting the threshold temperature Tth in multiple stages, the final adjustment of the threshold temperature Tth can be more accurately matched with the single chip temperature Tsen which is actually over-temperatured

6. Through recording the variation if the single chip temperature Tsen, the continuous monitoring can be achieved. It is helpful for system developers to know the parameters, electrical characteristics during the test stage, so as to increase the testing accuracy and efficiency.

The above description is exemplary only, and not restrictive. Any equivalent modification or change made without departing from the spirit and scope of the invention shall be included in the scope of the attached patent application.

What is claimed is:

1. A built-in temperature sensing device in a single chip, comprising:
a built-in temperature sensor for sensing a single chip temperature of the single chip;
a temperature comparator for receiving the single chip temperature and a threshold temperature as well as comparing the single chip temperature with the threshold temperature to generate an output signal, wherein the output signal is a first level signal when the single chip temperature is higher than the threshold temperature; and
a digital to analog converter (D/A converter) for coupling the temperature comparator to convert a digital threshold temperature to the threshold temperature.

2. The built-in temperature sensing device of claim 1, further comprising:
a time delay controller for receiving the output signal and generating a time delay signal.

3. The built-in temperature sensing device of claim 1, further comprising:
an interrupting controller for receiving the output signal and generating an interrupting control signal; and
a central processing unit (CPU) for receiving the interrupting control signal and generating the digital threshold temperature.

4. The built-in temperature sensing device of claim 1, further comprising:
an alarm control device for receiving the output signal and generating an alarm control signal: and
a disable control device for receiving the output signal and generating a disable control signal.

5. The built-in temperature sensing device of claim 4,
wherein the alarm control device couples an external alarm device and activates the external alarm device by the alarm control signal,
wherein the disable controller couples an external electronic device and disables the external electronic device by the disable control signal.

6. The built-in temperature sensing device of claim 5,
wherein whether the external electronic device needs to be disabled is determined according to an extent or a duration time of the single chip temperature being higher than the threshold temperature.

7. A built-in temperature sensing device in a single chip, comprising:
a built-in temperature sensor for sensing a single chip temperature of the single chip;
a temperature comparator for receiving the single chip temperature and a threshold temperature as well as comparing the single chip temperature with the threshold temperature to generate an output signal, wherein the output signal is a first level signal when the single chip temperature is higher than the threshold temperature;
an interrupting controller for receiving the output signal and generating an interrupting control signal; and
a central processing unit (CPU) for receiving the interrupting control signal and generating a digital threshold temperature.

8. The built-in temperature sensing device of claim 7, further comprising:
a digital to analog converter (D/A converter) for coupling the temperature comparator and the central processing unit to convert the digital threshold temperature to the threshold temperature.

9. The built-in temperature sensing device of claim 7, further comprising:
an alarm control device for receiving the output signal and generating an alarm control signal: and
a disable control device for receiving the output signal and generating a disable control signal.

10. The built-in temperature sensing device of claim 9,
wherein the alarm control device couples an external alarm device and activates the external alarm device by the alarm control signal,
wherein the disable controller couples an external electronic device and disables the external electronic device by the disable control signal.

11. The built-in temperature sensing device of claim 10, wherein whether the external electronic device needs to be disabled is determined according to an extent or a duration time of the single chip temperature being higher than the threshold temperature.

12. A protection method of a built-in temperature sensing device in a single chip, comprising following steps:
(a) sensing a single chip temperature of the single chip;
(b) comparing the single chip temperature with a threshold temperature to generate an output signal to a disable controller; and
(c) generating a disable control signal to disable an external electronic device by the disable controller when the single chip temperature is higher than the threshold temperature, wherein the external electronic device couples with the disable controller.

13. The protection method of claim 12, wherein the step (b) further comprises:
(b1) comparing the single chip temperature with the threshold temperature to generate the output signal to an alarm controller.

14. The protection method of claim 13, wherein the step (c) further comprises:
(c1) generating an alarm control signal by the alarm controller to activate an external alarm device coupling with the alarm controller when the single chip temperature is higher than the threshold temperature.

15. The protection method of claim 14, wherein the step (c) further comprises:
generating the disable control signal by the disable controller to disable the external electronic device after a time delay,
wherein the step (c1) further comprises:
generating the alarm control signal by the alarm controller to activate the external alarm device after a time delay.

16. The protection method of claim 12, wherein the step (c) further comprises determining whether the external electronic device needs to be disabled or not according to an extent or a duration time of the single chip temperature being higher than the threshold temperature.
